(19) United States
(12) Patent Application Publication
(10) Pub. No.: US 2025/0381962 A1
(43) Pub. Date: Dec. 18, 2025

(54) VEHICULAR TRAILER HITCHING ASSIST SYSTEM

(71) Applicant: Magna Electronics Inc., Auburn Hills, MI (US)

(72) Inventors: Jyothi P. Gali, Rochester Hills, MI (US); Jigneshkumar Natvarlal Vasoya, Brampton (CA); Mohammad Hossein Basiri, Waterloo (CA)

(21) Appl. No.: 19/240,300

(22) Filed: Jun. 17, 2025

Related U.S. Application Data
(60) Provisional application No. 63/661,202, filed on Jun. 18, 2024.

(51) Int. Cl. B60W 30/18; B60R 1/26; B60W 10/04; B60W 10/18; B60W 10/20; G06V 10/764; G06V 20/58; H04N 7/18

(52) U.S. Cl. CPC B60W 30/18036; B60R 1/26; B60W 10/04; B60W 10/18; B60W 10/20; G06V 10/764; G06V 20/58; H04N 7/183; B60R 2300/308; B60R 2300/808; B60W 2420/403; B60W 2510/1005; B60W 2520/06; B60W 2710/18; B60W 2710/20; B60W 2720/106

(57) ABSTRACT

A vehicular trailering assist system includes a camera disposed at a vehicle and viewing at least rearward of the vehicle and at least a portion of a hitch of the vehicle. The vehicular trailering assist system, via processing of captured image data, detects a plurality of trailers viewed by the camera and selects a target trailer. The system determines location of the hitch of the vehicle and a trailer coupler of the target trailer and determines a trailer angle of the target trailer relative to the vehicle. The system may determine a path between the vehicle and the target trailer based on the hitch of the vehicle, the trailer coupler of the target trailer and the determined trailer angle. The system, based on the determined path, may control steering of the vehicle during a reversing maneuver that reverses the vehicle along the determined path toward the target trailer.

### CROSS REFERENCE TO RELATED APPLICATION

The present application claims the filing benefits of U.S. provisional application Ser. No. 63/661,202, filed Jun. 18, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicular trailer assist systems is common and known. Examples of such known systems are described in U.S. Pat. Nos. 9,446,713 and 9,085,261, which are hereby incorporated herein by reference in their entireties.

### SUMMARY OF THE INVENTION

A vehicular trailering assist system includes a camera disposed at a vehicle equipped with the vehicular trailering assist system. The camera views at least rearward of the equipped vehicle and at least a portion of a hitch disposed at the equipped vehicle. The camera is operable to capture image data. The camera includes an imaging array with at least one million photosensors arranged in rows and columns. The system includes an electronic control unit (ECU) with electronic circuitry and associated software. Image data captured by the camera is transferred to the ECU. The electronic circuitry of the ECU includes at least one image processor. The ECU is operable to process image data captured by the camera and transferred to the ECU. The vehicular trailering assist system, via processing at the ECU of image data captured by the camera, detects a plurality of trailers viewed by the camera. The vehicular trailering assist system selects a target trailer from the plurality of detected trailers. The vehicular trailering assist system, at least in part via processing at the ECU of image data captured by the camera, (i) determines location of the hitch of the equipped vehicle and (ii) determines location of a trailer coupler of the target trailer relative to the equipped vehicle. The vehicular trailering assist system determines trailer angle of the target trailer relative to the equipped vehicle. Optionally, the vehicular trailering assist system determines a path between the equipped vehicle and the target trailer based on (i) the location of the hitch of the equipped vehicle, (ii) the location of the trailer coupler of the target trailer and (iii) the trailer angle of the target trailer relative to the equipped vehicle. The vehicular trailering assist system, responsive to determining the path between the equipped vehicle and the target trailer, may control steering of the equipped vehicle during a reversing maneuver that reverses the equipped vehicle along the determined path toward the target trailer.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a trailering assist system;

FIG. 2 is a view of exemplary trailer connectors and vehicle hitch connectors;

FIG. 3 is an image showing trailer identification;

FIG. 4 is an image showing a graphic overlay for trailer selection from among multiple trailers;

FIG. 5 is an image showing a graphic overlay of a determined path between a vehicle and a trailer;

FIG. 6 is an image showing a graphic overlay for a vehicle that has completed approaching a trailer; and

FIG. 7 is a block diagram of the trailering assist system of FIG. 1.

### DESCRIPTION OF THE PREFERRED EMBODIMENTS

A vehicle and trailer maneuvering system or trailering assist system and/or trailer hitching assist system and/or driving assist system operates to capture images exterior of the vehicle and trailer being towed by the vehicle and may process the captured image data to determine a path of travel for the vehicle and trailer and to detect objects at or near the vehicle and in the predicted path of the vehicle, such as to assist a driver of the vehicle in maneuvering the vehicle in a rearward direction. The system includes an image processor or image processing system that is operable to receive image data from one or more cameras and may provide an output to a display device for displaying images representative of the captured image data. Optionally, the system may provide a rearview display or a top down or bird's eye or surround view display or the like.

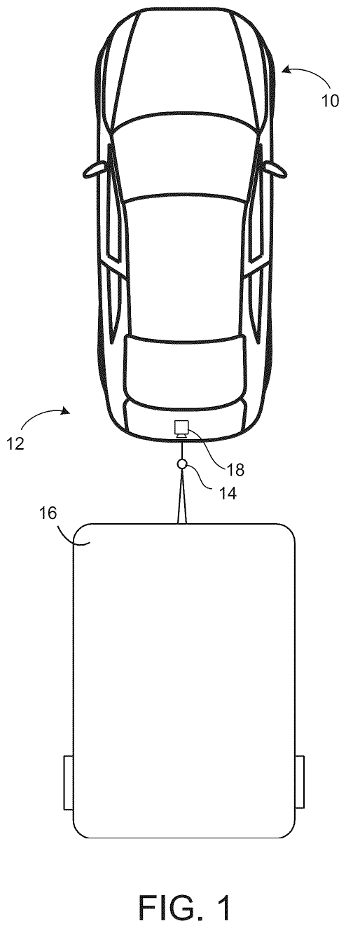

Referring now to the drawings and the illustrative embodiments depicted therein, a vehicle 10 includes a trailering assist system 12 that is operable to assist in backing up or reversing a vehicle toward a trailer. The trailering assist system 12 includes at least one exterior viewing vehicle-based imaging sensor or camera, such as a rearward viewing imaging sensor or camera 18 (and the system may optionally include multiple exterior viewing imaging sensors or cameras, such as a sideward/rearward viewing camera at respective sides of the vehicle), which captures image data representative of the scene exterior of the vehicle 10, which includes the hitch 14 and/or trailer 16, with the camera 18 having a lens for focusing images at or onto an imaging array or imaging plane or imager of the camera (FIG. 1). Optionally, the camera is a rear backup camera of the vehicle or a center-high-mounted stop lamp (CHMSL) camera of the vehicle. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The trailer maneuver assist system 12 includes a control or electronic control unit (ECU) or processor that is operable to process image data captured by the camera or cameras and may detect objects or the like and/or provide displayed images at a display device for viewing by the driver of the vehicle (the control and/or display device may be part of or incorporated in or at an interior rearview mirror assembly of the vehicle, or the control and/or the display device may be disposed elsewhere at or in the vehicle). The data transfer or signal communication from the camera to the ECU may comprise any suitable data or communication link, such as a vehicle network bus or the like of the equipped vehicle.

Implementations herein are directed toward systems and methods for a trailer hitch assist (THA) feature for a vehicle. The THA Feature uses an image sensor, such as a rear-viewing camera (e.g., disposed at the rear of the vehicle, such as a rear backup camera of the vehicle) of a surround view camera system. In some examples, the surround view camera system may comprise multiple cameras, and the THA feature may utilize image data from one or more of these cameras to generate a comprehensive view of the environment behind the vehicle. The THA feature detects or determines presence of multiple objects by processing the frames of image data received from the image sensor. For example, the THA feature may employ a trained object detection model to differentiate between classes of objects, such as trailers, pedestrians, other vehicles, and fixed obstacles. The THA feature identifies trailers and other objects in the field of view of a rear-view camera (e.g., a rear camera of a surround view camera system) between one meter and thirty meters (or ten meters, twenty meters, fifty meters, etc.) from the rear of the vehicle (e.g., from the bumper or trunk of the vehicle).

The THA feature may detect/estimate angles (e.g., pitch, yaw, and/or roll angle) between the equipped vehicle and a selected target trailer. The yaw angle, for instance, describes the horizontal angle between the longitudinal axis of the vehicle and the longitudinal axis of the trailer. The pitch angle may be used to assess the relative height difference between the vehicle's hitch and the trailer's coupler. The THA feature may classify appropriate objects as trailers and localizes (i.e., identifies and determines a location of objects relative to the vehicle/camera) the hitch connector (e.g., the hitch ball or hitch coupler) disposed at the vehicle. Localization of the hitch connector may involve the THA feature processing image data to identify a specific region of interest corresponding to the hitch connector and determining its coordinates within the image frame. The THA feature additionally or alternatively identifies and localizes the connector on the trailer within the field of view of the rear camera.

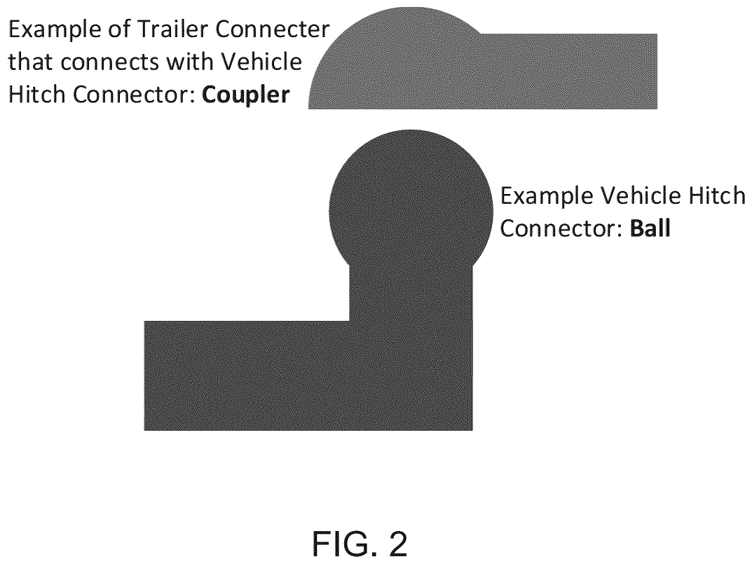

The THA feature may detect and classify different types of hitch and trailer connectors (FIG. 2). For example, the THA features may classify a connector/coupler as a ball connector, a pintle connector, a hook type connector, a lunette ring connector, etc. Because different hitch types may have different geometric properties and coupling requirements, this classification may inform the path planning and final alignment tolerances of the THA feature. The THA feature may additionally or alternatively classify different trailer types. For example, the THA feature may classify a trailer as a conventional trailer (e.g., a trailer where the hitch connector couples to the vehicle behind the rear bumper of the equipped vehicle) or a non-conventional trailer (e.g., a fifth-wheel trailer, a gooseneck trailer, or other trailer type where the hitch connector does not couple behind the rear bumper of the vehicle). The THA feature may be operable with both conventional and non-conventional trailer types. The THA feature may adjust thresholds based on the type of connector/coupler and/or the type of trailer (e.g., distance from vehicle thresholds, height thresholds, etc.). For example, a smaller, more precise alignment threshold may be used for a ball-type hitch as compared to a pintle and lunette ring combination, which may permit a greater margin of error.

The THA feature may be activated using a soft button (e.g., via a touchscreen or the like), a physical hardware button, via a voice command, etc. Optionally, the THA feature may be activated with the equipped vehicle in any gear position (e.g., park, neutral, forward, reverse, etc.). In some implementations, the system may check for certain preconditions before allowing activation, such as verifying the vehicle speed is below a predetermined threshold, for example, five miles per hour. In some aspects, the THA feature may activate automatically when the vehicle is shifted into a reverse gear and a trailer is detected by the system within a predefined range. In scenarios where the vehicle is not in the reverse gear, the THA feature may automatically change the current gear of the vehicle to the reverse gear. Alternatively, the THA feature may prompt the driver to change the current gear of the vehicle to the reverse gear. Such a prompt may be a visual message displayed on a screen inside the vehicle, an audible alert, or a combination thereof. The system may be user configurable between automatic gear switching and driver prompting.

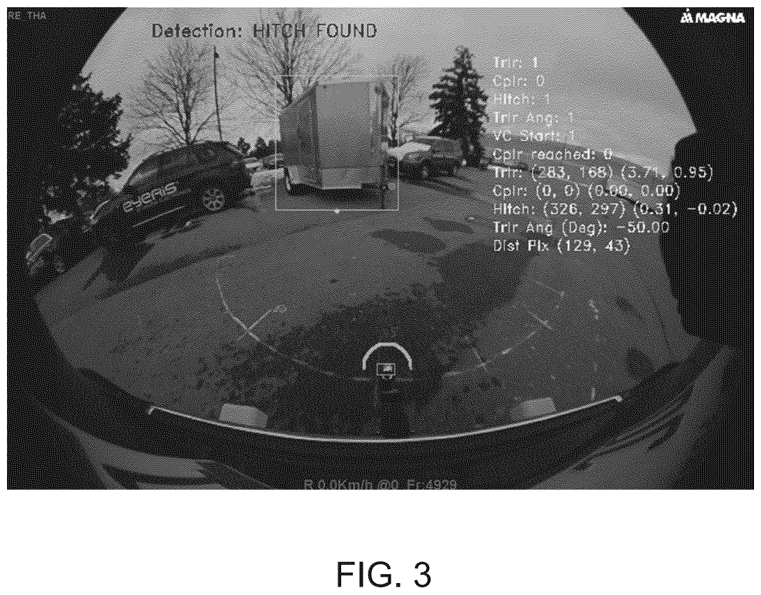

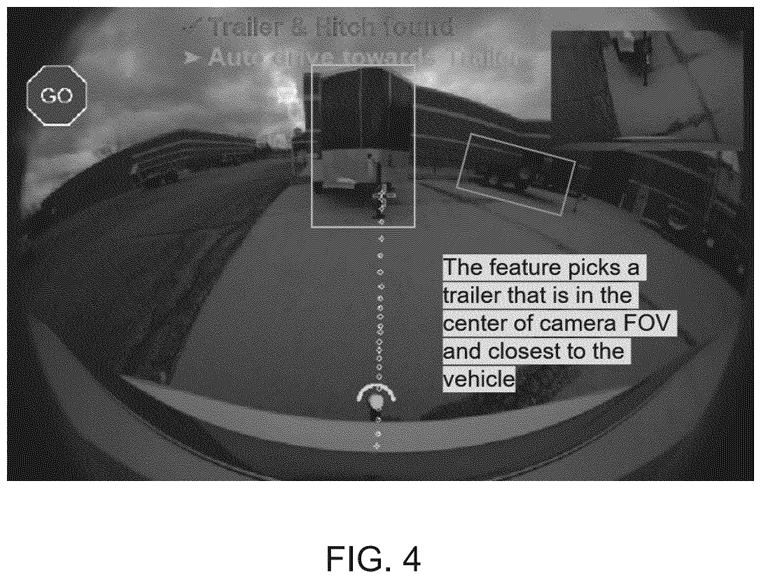

As shown in FIGS. 3 and 4, when the THA feature has been activated (e.g., by the driver of the vehicle), the THA feature may find and identify all trailers in the field of view of the rear camera and the hitch connected to the equipped vehicle. The identification process may involve the THA feature applying a visual overlay, such as a bounding box or a colored highlight, to the image of the trailer or trailers on a display screen to indicate to the driver which objects the system has identified as potential targets. In FIG. 3, the THA feature identifies a single trailer with a hitch, while in FIG. 4, the THA feature identifies two different trailers in the field of view of the camera. The THA feature may continuously process incoming image data to track the positions of the identified trailers, even if the vehicle or the trailers are moving.

After identification of trailers, the THA feature may implement trailer selection. For example, information may be displayed to a user via a center stack display, instrument panel cluster, etc., that highlights and automatically selects a trailer to inform the user and provide an option for the user to select a different trailer (i.e., when multiple trailers present in the field of view of the camera). Optionally, the automatically selected trailer may be highlighted with a primary color, for example green, while other available trailers are highlighted with a secondary color, for example yellow. After trailer selection and, optionally, trailer confirmation (i.e., by the user), the THA feature may begin backing up the vehicle towards the selected trailer. As shown in FIG. 4, the THA feature may automatically select the trailer that is closest to the vehicle, the trailer that is most aligned with the longitudinal axis of the vehicle, a trailer that is determined to be both substantially in the center of the camera's field of view and the closest to the vehicle, and/or a trailer that was most recently hitched to the vehicle (i.e., based on identifying the trailer from visual characteristics such as a size or shape of the trailer, or based on patterns such as a barcode or the like). In some examples, the automatic selection logic may be based on a confidence score generated by the THA feature for each potential target. The THA feature may automatically select a trailer when the trailer is the only trailer in the field of view of the camera.

Alternatively, the THA feature may display (e.g., on a display disposed within the vehicle) a message (such as a pop-up message) prompting the user to locate and/or select a trailer (e.g., from among a list of identified trailers) anywhere in the field of view of the rear-view camera. For example, the THA feature may display an image captured by the rearview camera and the user may select the desired trailer using a touchscreen or via soft or hardware buttons. In some implementations, the user may interact directly with the displayed image, for example, by touching or tapping on the representation of the desired trailer on the touchscreen. Upon selection, the THA feature may provide a visual confirmation, such as by changing the color of a bounding box surrounding the selected trailer or by displaying an icon next to the selection. In other examples, the user may cycle through the identified trailers using physical buttons on the steering wheel or center console, with each trailer being highlighted sequentially on the display. Optionally, the system may support voice commands for trailer selection, wherein the user may state a command such as “select the trailer on the left” or “select the closest trailer”.

Optionally, the THA feature provides a message (e.g., a pop-up message) on a display (e.g., the center stack display) to the driver of the vehicle to ensure that the coupler is higher (relative to the ground) than the hitch to avoid collision and to provide better alignment. This prompt may require a confirmation from the user before the THA feature initiates any vehicle movement. For instance, the user may need to select an “OK” or “Confirm” button on the display to proceed. If the user indicates that the coupler is not higher than the hitch, the THA feature may remain in a standby mode and display instructions for the user to manually adjust the trailer jack. In some examples, the THA feature may use the camera system to estimate the relative heights and may only display the warning if a potential height mismatch is detected. Upon selection of the trailer either by the user or by the THA feature, the THA feature may track the trailer and/or the coupler of the trailer. This is useful in the scenario when multiple trailers or multiple similar objects present in the field of view of the camera. The tracking may be performed by an object tracking algorithm that continuously analyzes subsequent image frames to follow the motion of the selected trailer and its components, even if partially obscured for short periods.

Once the trailer has been selected, the THA feature estimates the trailer angle with respect to the longitudinal axis of the vehicle. That is, the THA feature estimates or determines an angle between the longitudinal axis of the trailer and the longitudinal axis of the vehicle. The THA feature may then localize the trailer connector and generate/correct a path from the vehicle's current location to the trailer. After detecting all required trailer objects, the THA feature plans a path that aligns the coupler and hitch within a threshold distance (e.g., within +/−2 centimeters) and reduces the difference in angle between vehicle and trailer to avoid collisions (i.e., attempts to minimize the trailer angle). The path may be generated as a sequence of waypoints or as a continuous curve, such as a spline, for the vehicle to follow. The alignment tolerance may be adjusted based on the type of hitch connector that was previously classified by the system. For example, a ball hitch may require a tighter tolerance than a pintle hook and lunette ring combination. Minimizing the final angle between the vehicle and trailer provides for a more stable configuration immediately after coupling is complete, allowing the driver to pull forward with greater ease.

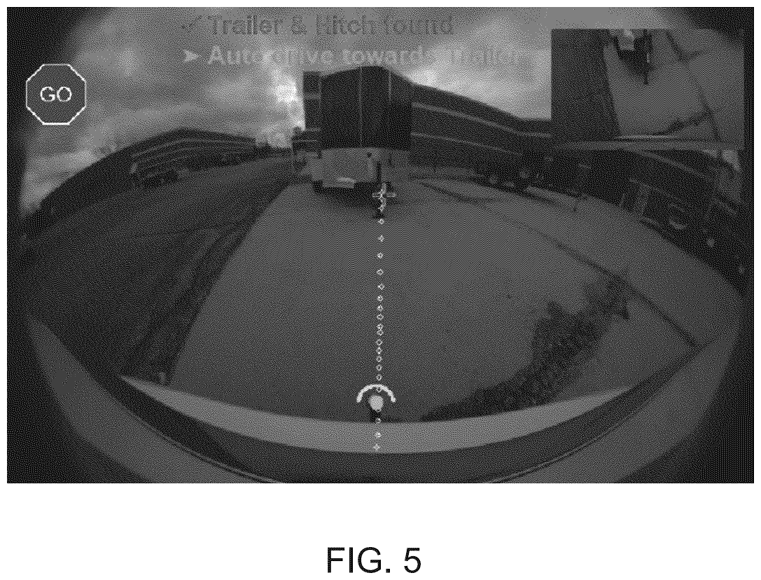

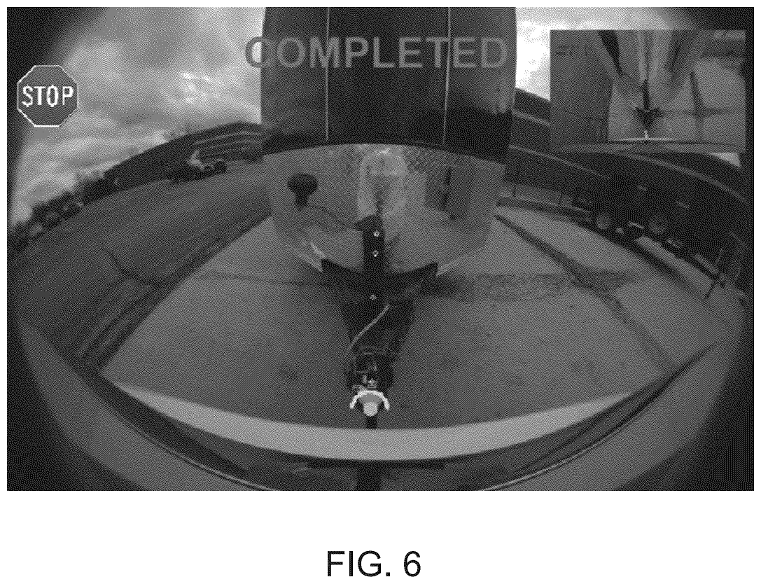

The THA feature may continue to update the location of trailer, trailer connector, hitch connector, and/or trailer angle along with path corrections during the course of the maneuver (i.e., as the vehicle reverses toward the trailer) by controlling steering of the vehicle. Optionally, the driver is responsible for braking/acceleration and/or gear of the vehicle. These different levels of automation may be presented to the user as selectable modes, such as a guidance mode where only trajectory lines are shown, a steering assist mode where the system controls steering, and a fully autonomous mode where the system controls steering, throttle, braking, and gear selection. In other examples, the THA feature also controls the braking/acceleration and/or gear of the vehicle. In yet other examples, the THA feature displays an overlay on image data captured by the rear-view camera that represents the determined path or trajectory (e.g., a guide such as a dotted or solid line) between hitch connecter on vehicle and the trailer connector for the vehicle to follow (FIGS. 5 and 6). In some of these examples, the driver may be responsible for steering while the THA feature determines and displays the path or trajectory for the driver to follow. The color or style of the displayed guideline may change to provide feedback to the driver, for instance, changing from yellow to green as the vehicle accurately follows the planned path, or flashing red if the vehicle deviates from the path by more than a threshold amount.

The THA feature may display user assist/warning/fault messages during operation. The THA feature may abort the reversing maneuver if any obstacle is detected within or near (e.g., within a threshold distance) of the maneuver path. Optionally, when an object is detected, the THA feature may pause the maneuver (i.e., by braking the vehicle or instructing the driver to brake the vehicle) for a threshold period of time to determine whether the object moves out of the path. For example, if a pedestrian or another vehicle crosses the planned path, the system may automatically apply the brakes and pause for a few seconds. If the object does move, the THA feature may resume the reversing maneuver. If the object does not move within the threshold period of time, the THA feature may abort the reversing maneuver or may adjust the rearward path of travel to avoid the detected object. When a maneuver is aborted, the THA feature may cause the vehicle to enter a safe state, such as engaging the park brake, and may display a message to the user explaining the reason for the abortion, for example, “Maneuver aborted: Obstacle detected in path.”

The THA feature may automatically display a bird's-eye view video image of the vehicle (e.g., by using image data captured by multiple surround view cameras) along with image data captured by the rear-view camera once a distance between vehicle and the trailer connector is within a threshold distance. For example, the system may present a split-screen display to the driver, with the standard rear-view image on one portion of the screen and the synthesized bird's-eye view on another portion, providing enhanced situational awareness of the vehicle's immediate surroundings. The threshold distance for triggering this view may be a configurable parameter, for example, a distance of two meters or less between the vehicle's hitch and the trailer's coupler. The THA feature may change or adjust a transparency of graphics or overlays displayed on images captured by the camera so that the user can more easily visually confirm that the vehicle hitch has reached the trailer connector such that the user only needs to lower the trailer connector onto the vehicle hitch connector. For example, the THA feature may cause the guideline or other overlay to gradually become more transparent as the vehicle approaches the trailer (i.e., based on a distance between the equipped vehicle and the trailer) so that the vehicle hitch and trailer coupler are easily visible. As another example, the THA feature may cause graphical representations of the vehicle and/or the trailer connector to fade or become translucent, allowing the driver an unobstructed view of the physical hitch and coupler components during alignment. Optionally, a graphical overlay representing the planned path may begin at full opacity and linearly fade to 25 percent opacity as the vehicle covers the final meter of the path, ensuring the graphic provides guidance without obscuring the real-world view.

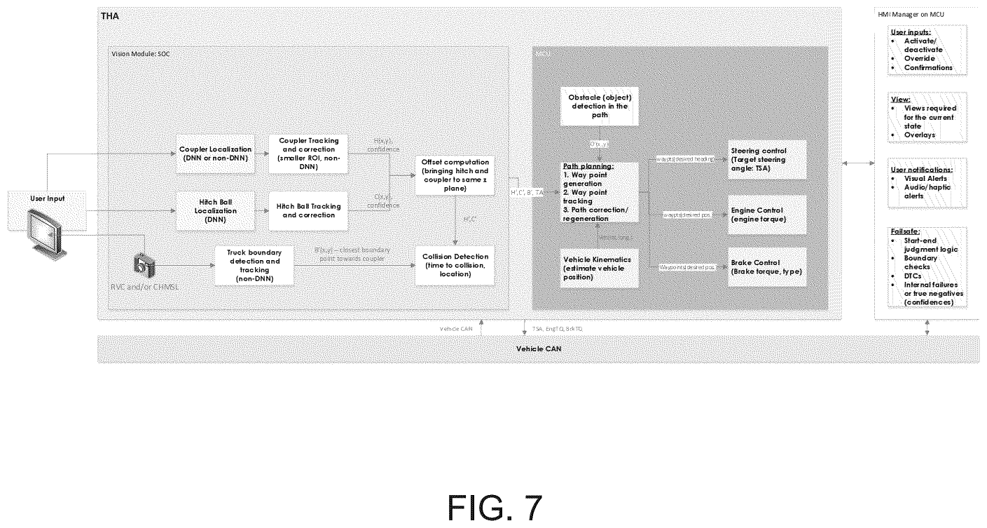

Referring now to FIG. 7, the THA feature may include a model (such as a machine learning model that includes a deep neural network (DNN) or other deterministic model) for coupler localization. These models may be trained using a vast and diverse dataset of images depicting various trailer and hitch types under a plurality of environmental conditions, such as different lighting (e.g., bright sunlight, low light, shadows) and weather (e.g., rain, snow), to enhance the robustness and accuracy of the detection. The same or a different model/algorithm may track and correct the coupler position during the reversing maneuver. The same or a different model (e.g., a separate DNN) may perform hitch ball localization and/or hitch ball tracking/correction. The THA feature may include a model or algorithm for vehicle boundary detection and tracking (e.g., a non-DNN model) which may, in some examples, utilize traditional computer vision methods like edge detection to define the vehicle's perimeter for collision avoidance calculations. Based on confidence scores, the THA feature may determine an offset that brings the hitch and coupler to the same height (i.e., z coordinate). The THA feature may perform collision detection (e.g., time to collision, location, etc.). The THA feature at, for example, a microcontroller (MCU) or other processor, performs path planning, which may include waypoint generation, waypoint tracking, and/or path correction/regeneration. Waypoint generation, for instance, may involve creating a sequence of intermediate vehicle positions and orientations that define the intended path, and path correction may involve iteratively recalculating these waypoints in real-time based on updated sensor data from the cameras. The processor may perform obstacle detection (e.g., an obstacle in the determined path). The path determination may take into account vehicle kinematics (i.e., to estimate the vehicle's position). The THA feature, based on the path determination, may control steering, acceleration, and/or braking. The THA feature may communicate with a human-machine interface (HMI) regarding, for example, user inputs (e.g., activation/deactivation of the THA feature, overrides, confirmations, etc.), current views displayed on a display within the vehicle (e.g., rearview, bird's-eye view, other surround views, etc.), user notifications (e.g., visual alerts, audible alerts, and/or haptic alerts), and/or failsafe communications (e.g., start-end judgment logic, boundary checks, diagnostic trouble codes (DTCs), internal failures, true negatives (confidence scores), etc.). An override input, for example, may be detected when the user grasps the steering wheel with sufficient force during an automated steering maneuver, causing the THA feature to immediately cede control to the driver. An audible alert may include a series of chimes that increase in frequency as the trailer's coupler nears the vehicle's hitch, while a failsafe communication may involve logging a DTC if a camera signal is lost or if a confidence score from a localization model falls below a predetermined threshold.

Thus, the THA feature, upon selection/confirmation of the target trailer (e.g., from among multiple trailers in the field of view of a camera) by either the user or by the THA feature, automatically detects and localizes the trailer connector, the trailer orientation, and the hitch connector on the equipped vehicle. This localization may involve estimating the three-dimensional coordinates of the components relative to a coordinate system of the vehicle. The THA feature accurately aligns the hitch connector on the towing vehicle with the connector on the selected trailer to a point where the trailer connector only needs to be lowered onto the hitch. Before beginning the reversing maneuver toward the selected trailer and/or during the reversing maneuver towards the selected trailer, the THA feature detects/estimates all required dimensions of the trailer along with the hitch connector on the vehicle and the vehicle's dimensions. In some examples, the dimension estimation is performed using a technique such as photogrammetry, where the system analyzes the size of the trailer as it appears in the image data in conjunction with known camera parameters (e.g., camera height and focal length) to approximate the trailer's width and the distance from the coupler to the trailer's axle or axles. In other examples, a user may input the trailer dimensions once, and the system may store these dimensions and associate them with a visually recognized trailer for future use. Using these dimensions, the THA feature determines the jackknife angle and/or collision angle between the vehicle and the selected trailer. The jackknife angle represents an angle between the longitudinal axis of the vehicle and the longitudinal axis of the trailer beyond which the trailer is at risk of contacting the vehicle during a turn, and the determination of this angle is a proactive safety measure to prevent damage to either the vehicle or the trailer during and after the hitching process.

To align the vehicle with the selected trailer, the THA feature controls the vehicle by controlling or adjusting the steering, braking, acceleration, and/or gear of the vehicle. In some implementations, the THA feature generates control commands that are transmitted via a vehicle communication bus, such as a controller area network (CAN) bus, to the appropriate vehicle control modules, including an electric power steering (EPS) system, an electronic brake controller, and/or a powertrain control module. In some scenarios, when the target trailer is at a particular angle (e.g., a trailer angle relative to the vehicle greater than a threshold angle), the THA feature provides steering control to reduce the angle between the trailer and the vehicle during the maneuver of the vehicle towards the trailer. For example, instead of commanding a simple straight-line reverse path that may be impossible to complete without exceeding the jackknife angle, the THA feature may generate a more complex path, such as an ‘S-curve’ or a multi-point path, to gradually decrease the vehicle-to-trailer angle as the vehicle approaches the trailer. The THA feature may ensure that the angle between the trailer and the vehicle at the time of alignment of vehicle and trailer connectors is less than the jackknife angle of the trailer and/or the collision angle so that the user can back up immediately after connecting a trailer without any safety concerns.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of the trailering assist systems or trailer angle detection systems or trailer hitch assist systems described in U.S. Pat. Nos. 11,787,339; 11,613,210; 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0028111; US-2022-0027644; US-2022-0024391; US-2021-0170947; US-2021-0170820; US-2021-0078634; US-2021-0053572; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. No. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a camera disposed at a vehicle equipped with the vehicular trailering assist system, the camera viewing at least rearward of the equipped vehicle and viewing at least a portion of a hitch disposed at the equipped vehicle;
wherein the camera is operable to capture image data;
wherein the camera comprises an imaging array, and wherein the imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises at least one image processor;
wherein the ECU is operable to process image data captured by the camera and transferred to the ECU;
wherein the vehicular trailering assist system, via processing at the ECU of image data captured by the camera, detects a plurality of trailers viewed by the camera;
wherein the vehicular trailering assist system selects a target trailer from the plurality of detected trailers;
wherein the vehicular trailering assist system, at least in part via processing at the ECU of image data captured by the camera, (i) determines location of the hitch of the equipped vehicle and (ii) determines location of a trailer coupler of the target trailer relative to the equipped vehicle; and
wherein the vehicular trailering assist system determines trailer angle of the target trailer relative to the equipped vehicle.

2. The vehicular trailering assist system of claim 1, wherein the camera comprises a rearward viewing camera that is part of a surround view vision system of the equipped vehicle.

3. The vehicular trailering assist system of claim 1, wherein the camera comprises a rear backup camera of the equipped vehicle.

4. The vehicular trailering assist system of claim 1, wherein the vehicular trailering assist system selects the target trailer responsive to a user input.

5. The vehicular trailering assist system of claim 1, wherein the vehicular trailering assist system selects the target trailer based on a location of the target trailer within the field of view of the camera.

6. The vehicular trailering assist system of claim 1, wherein the vehicular trailering assist system selects the target trailer based on distance of the target trailer from the equipped vehicle.

7. The vehicular trailering assist system of claim 1, wherein the vehicular trailering assist system classifies the hitch of the equipped vehicle as one of a plurality of hitch types.

8. The vehicular trailering assist system of claim 1, wherein the vehicular trailering assist system classifies the trailer coupler of the target trailer as one of a plurality of trailer coupler types.

9. The vehicular trailering assist system of claim 1, wherein the vehicular trailering assist system, prior to controlling steering of the equipped vehicle, shifts the equipped vehicle into a reverse gear.

10. The vehicular trailering assist system of claim 1, wherein the vehicular trailering assist system determines a path between the equipped vehicle and the target trailer based on (i) the determined location of the hitch of the equipped vehicle, (ii) the determined location of the trailer coupler of the target trailer and (iii) the determined trailer angle of the target trailer relative to the equipped vehicle, and wherein the vehicular trailering assist system, based at least in part on the determined path between the equipped vehicle and the target trailer, controls steering of the equipped vehicle during a reversing maneuver to maneuver the equipped vehicle along the determined path toward the target trailer.

11. The vehicular trailering assist system of claim 10, wherein the vehicular trailering assist system displays, on a display disposed within the equipped vehicle, an overlay representative of the determined path overlaying images derived from image data captured by the camera.

12. The vehicular trailering assist system of claim 11, wherein the vehicular trailering assist system changes a transparency of the overlay based on a distance between the equipped vehicle and the target trailer.

13. The vehicular trailering assist system of claim 10, wherein the vehicular trailering assist system, responsive to determining the path between the equipped vehicle and the target trailer, controls (i) acceleration of the equipped vehicle during the reversing maneuver and (ii) braking of the equipped vehicle during the reversing maneuver.

14. The vehicular trailering assist system of claim 10, wherein the vehicular trailering assist system determines a jackknife angle of the target trailer, and wherein the vehicular trailering assist system determines the path between the equipped vehicle and the target trailer further based on the determined jackknife angle of the target trailer.

15. The vehicular trailering assist system of claim 1, wherein the imaging array comprises a CMOS imaging array.

16. A vehicular trailering assist system, the vehicular trailering assist system comprising:
a camera disposed at a vehicle equipped with the vehicular trailering assist system, the camera viewing at least rearward of the equipped vehicle and viewing at least a portion of a hitch disposed at the equipped vehicle, wherein the camera comprises a rear backup camera of the equipped vehicle;
wherein the camera is operable to capture image data;
wherein the camera comprises an imaging array, and wherein the imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises at least one image processor;
wherein the ECU is operable to process image data captured by the camera and transferred to the ECU;
wherein the vehicular trailering assist system, via processing at the ECU of image data captured by the camera, detects a plurality of trailers viewed by the camera;
wherein the vehicular trailering assist system selects a target trailer from the plurality of detected trailers;
wherein the vehicular trailering assist system, at least in part via processing at the ECU of image data captured by the camera, (i) determines location of the hitch of the equipped vehicle and (ii) determines location of a trailer coupler of the target trailer relative to the equipped vehicle;
wherein the vehicular trailering assist system determines trailer angle of the target trailer relative to the equipped vehicle;
wherein the vehicular trailering assist system determines a path between the equipped vehicle and the target trailer based on (i) the determined location of the hitch of the equipped vehicle, (ii) the determined location of the trailer coupler of the target trailer and (iii) the determined trailer angle of the target trailer relative to the equipped vehicle; and
wherein the vehicular trailering assist system, based at least in part on the determined path between the equipped vehicle and the target trailer, controls steering of the equipped vehicle during a reversing maneuver to maneuver the equipped vehicle along the determined path toward the target trailer.

17. The vehicular trailering assist system of claim 16, wherein the vehicular trailering assist system displays, on a display disposed within the equipped vehicle, an overlay representative of the determined path overlaying images derived from image data captured by the camera.

18. The vehicular trailering assist system of claim 17, wherein the vehicular trailering assist system changes a transparency of the overlay based on a distance between the equipped vehicle and the target trailer.

19. The vehicular trailering assist system of claim 16, wherein the vehicular trailering assist system, responsive to determining the path between the equipped vehicle and the target trailer, controls (i) acceleration of the equipped vehicle during the reversing maneuver and (ii) braking of the equipped vehicle during the reversing maneuver.

20. The vehicular trailering assist system of claim 16, wherein the vehicular trailering assist system determines a jackknife angle of the target trailer, and wherein the vehicular trailering assist system determines the path between the equipped vehicle and the target trailer further based on the determined jackknife angle of the target trailer.

21. A vehicular trailering assist system, the vehicular trailering assist system comprising:
a camera disposed at a vehicle equipped with the vehicular trailering assist system, the camera viewing at least rearward of the equipped vehicle and viewing at least a portion of a hitch disposed at the equipped vehicle;
wherein the camera is operable to capture image data;
wherein the camera comprises an imaging array, and wherein the imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises at least one image processor;
wherein the ECU is operable to process image data captured by the camera and transferred to the ECU;
wherein the vehicular trailering assist system, via processing at the ECU of image data captured by the camera, detects a plurality of trailers viewed by the camera;
wherein the vehicular trailering assist system selects a target trailer from the plurality of detected trailers based on one selected from the group consisting of (i) a location of the target trailer within the field of view of the camera, (ii) distance of the target trailer from the equipped vehicle and (iii) a user input;
wherein the vehicular trailering assist system, at least in part via processing at the ECU of image data captured by the camera, (i) determines location of the hitch of the equipped vehicle and (ii) determines location of a trailer coupler of the target trailer relative to the equipped vehicle;
wherein the vehicular trailering assist system determines a path between the equipped vehicle and the target trailer based on (i) the determined location of the hitch of the equipped vehicle and (ii) the determined location of the trailer coupler of the target trailer; and
wherein the vehicular trailering assist system, based at least in part on the determined path between the equipped vehicle and the target trailer, controls steering of the equipped vehicle during a reversing maneuver to maneuver the equipped vehicle along the determined path toward the target trailer.

22. The vehicular trailering assist system of claim 21, wherein the camera comprises a rearward viewing camera that is part of a surround view vision system of the equipped vehicle.

23. The vehicular trailering assist system of claim 21, wherein the camera comprises a rear backup camera of the equipped vehicle.

24. The vehicular trailering assist system of claim 21, wherein the vehicular trailering assist system, prior to controlling steering of the equipped vehicle, shifts the equipped vehicle into a reverse gear.
